(19) United States
(12) Patent Application Publication
(10) Pub. No.: US 2016/0214679 A1
(43) Pub. Date: Jul. 28, 2016

(54) Teeter Drive Vehicle

(71) Applicant: Gilad Segev, Valley Village, CA (US)

(72) Inventor: Gilad Segev, Valley Village, CA (US)

(21) Appl. No.: 14/605,817

(22) Filed: Jan. 26, 2015

(51) Int. Cl. B62M 1/28; B62K 17/00; B62M 9/02

(52) U.S. Cl. CPC B62M 1/28; B62M 9/02; B62K 17/00

(57) ABSTRACT

A vehicle which may be propelled by alternating depression of pedals. The vehicle comprises a chassis having a forward end, at least three wheels rotatably supported on the chassis, and a pedal drive for rotating at least one driven wheel in a direction toward the forward end. The pedal drive includes a first pedal and a second pedal, one located towards the forward end and the other located away from the forward end. In operation, one pedal is depressed while the other pedal ascends. A unidirectional clutch permits free wheeling and assures that pedal inputs propel the vehicle forwardly. Optionally, the pedal drive includes a ratio varying gearset.

### FIELD OF THE DISCLOSURE

The present disclosure relates to wheeled vehicles, and more particularly, to wheeled vehicles powered from alternating depression of pedals.

### BACKGROUND

Vehicles propelled by human riders have long been popular, bicycles being a prominent example. However, bicycles constrain the rider to maintain a generally seated position. There exists a need for human powered vehicles that do not constrain their riders to maintain a seated position.

Scooters enable riders to maintain a generally standing position. However, propulsion of an ordinary scooter requires periodically pushing off against the ground with one leg. Body movements returning the leg it its original position prior to pushing off are somewhat demanding.

There exists a need for a human powered vehicle which overcomes the above noted objections.

### SUMMARY

The present disclosure addresses the above stated situation by providing a multi-wheeled scooter which is propelled by teetering motion by the human rider. This is desirable because teetering motion minimizes those body movements required to return a leg to an initial posture prior to the next power stroke. Teetering motion also minimizes overall body motion required to propel the vehicle, which is regarded as being more efficient than operating orbiting pedals typical of bicycles.

It is an object to provide improved elements and arrangements thereof by apparatus for the purposes described which is inexpensive, dependable, and fully effective in accomplishing its intended purposes.

These and other objects will become readily apparent upon further review of the following specification and drawings.

### BRIEF DESCRIPTION OF THE DRAWINGS

Various objects, features, and attendant advantages of the present disclosure will become more fully appreciated as the same becomes better understood when considered in conjunction with the accompanying drawings, in which like reference characters designate the same or similar parts throughout the several views, and wherein:

FIG. 1 is a perspective view of power developing components of a teeter driven vehicle, according to at least one aspect of the disclosure;

FIG. 2 is a side view of FIG. 1;

FIG. 3 is a top plan view of a vehicle using the power developing components of FIG. 1;

FIG. 4 is a perspective view of power developing components of a teeter driven vehicle, according to at least one further aspect of the disclosure;

FIG. 5 is a side view of FIG. 4;

FIG. 6 is a top plan view of a vehicle using the power developing components of FIG. 4;

FIG. 7 is a top plan view of a vehicle using a teeter drive, according to at least one further aspect of the disclosure;

FIG. 8 is a top plan view of a vehicle using a teeter drive, according to at least another aspect of the disclosure; and

FIG. 9 is a detail side view of the center of FIG. 8.

### DETAILED DESCRIPTION

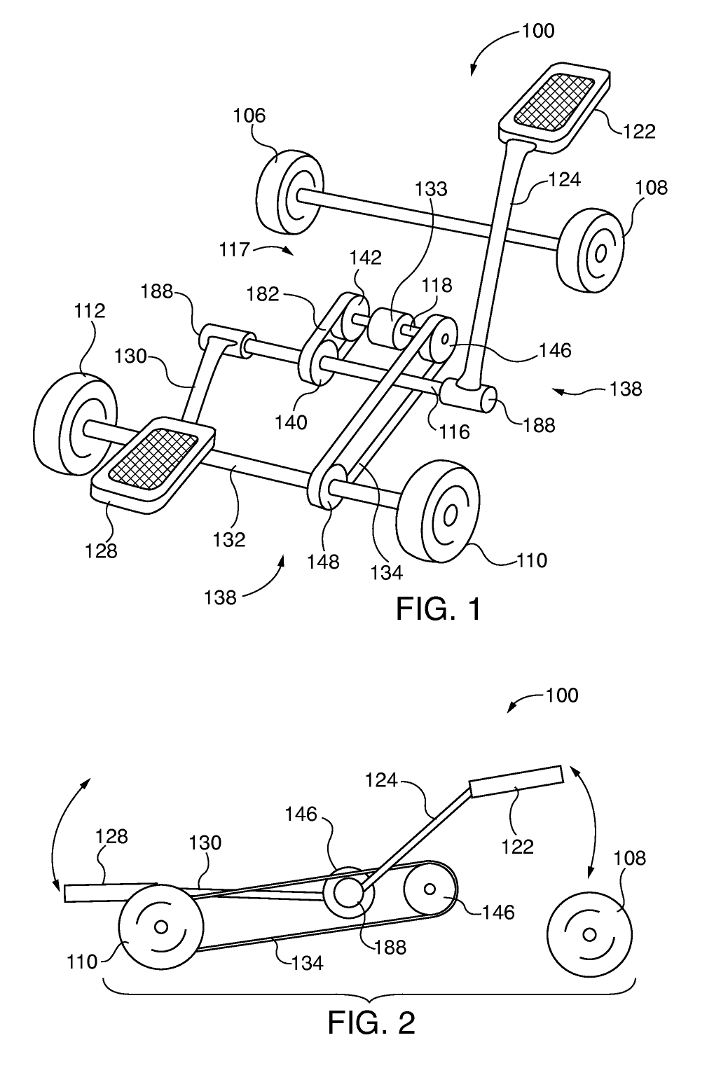

Referring first to FIGS. 1-3, according to at least one aspect of the invention, there is shown a vehicle 100 which may be propelled by alternating depression of pedals (e.g., pedals 122, 128). Vehicle 100 comprises a chassis 102 having a forward end 104, with at least three wheels (e.g., wheels 106, 108, 110, 112) rotatably supported on chassis 102. The at least three wheels include at least one unpowered wheel and at least one driven wheel. Vehicle 100 comprises a pedal drive 114 for rotating the at least one driven wheel in a direction such that the chassis 102 moves toward the forward end 104 when the at least one driven wheel is rotated by the pedal drive 114.

Pedal drive 114 includes an input shaft 116 rotatably supported by chassis 102, a first torque transmitting element 117 arranged to transmit torque from input shaft 116 to output an shaft 118, a first pedal input assembly 120 connected to input shaft 116, first pedal input assembly 120 comprising a first pedal 122 and a first arm 124 connecting first pedal 122 to input shaft 116, and a second pedal input assembly 126. Second pedal input assembly 126 is connected to input shaft 116, second pedal input assembly 126 comprising a second pedal 128 and a second arm 130 connecting second pedal 128 to input shaft 116.

A drive axle 132 is fixed to the at least one driven wheel and is rotatably connected to input shaft 116. A unidirectional clutch 133 is located between input shaft 116 and a drive axle 132 First pedal input assembly 120 and second pedal input assembly 126 are connected to input shaft 116 such that when first pedal 122 is being depressed, second pedal 128 is rising.

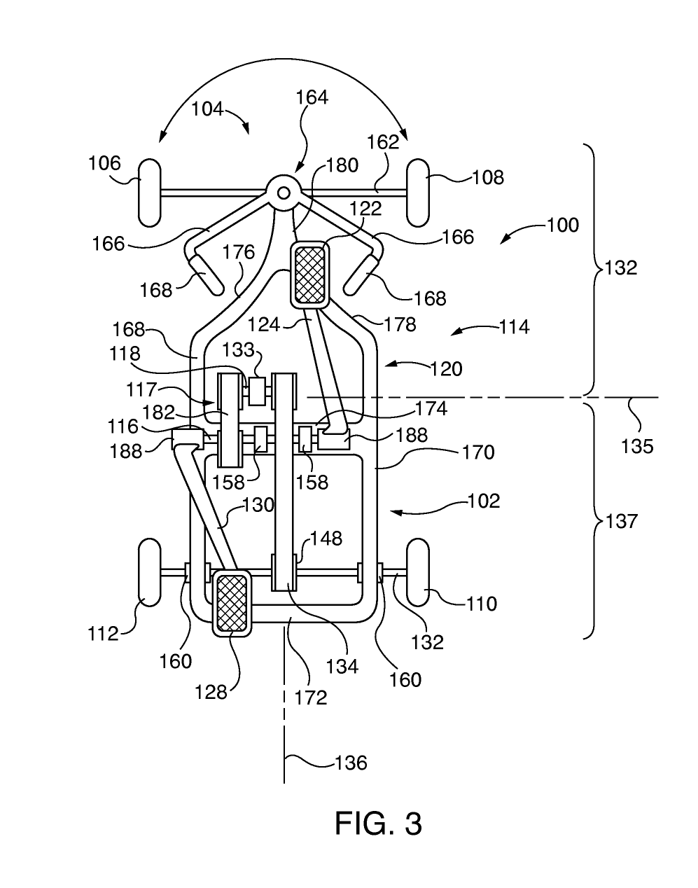

Chassis 102 has a forward half 132 and a rear half 137. First pedal 122 is located over the forward half 132 of the chassis 102. Second pedal 128 is located over rear half 137 of chassis 102. Forward and rear halves 132, 137 are separated by a line of demarcation 135 in FIG. 3.

It should be noted at this point that orientational terms such as over and below refer to the subject drawing as viewed by an observer. The drawing figures depict their subject matter in orientations of normal use, which could obviously change with changes in position of the subject matter. Therefore, orientational terms must be understood to provide semantic basis for purposes of description only, and do not imply that their subject matter can be used only in one position.

In the example of FIGS. 1-3, the at least one driven wheel comprises two driven wheels 110, 112. Similarly, the at least one unpowered wheel comprises two unpowered wheels 106, 108.

Chassis 102 has a longitudinal center line 136 (FIG. 3). First pedal 122 is located on one side of longitudinal center line 136, and second pedal 128 is located on an opposed side of longitudinal center line 136.

Pedal drive 114 includes an output shaft 118 rotatably supported by chassis 102. Output shaft 118 parallel to input shaft 116. A second torque transmitting element 134 is arranged to transmit torque from output shaft 118 to drive axle 132.

Referring generally to FIGS. 1 and 2 and particularly to FIG. 3, rotatable elements such as input shaft 116, output shaft 118, and drive axle 132 are rotatably secured to chassis 102 by trunnion bearings 158 or corresponding supports, regardless of whether these are actually shown. Similarly, drive axle 132 is supported by trunnion bearings 160. A front axle 162 may be fixed to a steering column 164. Steering bars 166 having respective grips 168 is fixed to steering column 164. Steering column 164 may be supported by suitable bearings (not visible in FIG. 3) fixed to chassis 102.

In the example of FIG. 3, chassis 102 comprises rigid left and right longitudinal members 168, 170, rigid rear cross member 172, and a rigid cross member 174. right and left longitudinal members 168, 170 include respective diagonal members 176, 178 which intersect at a rigid forward member 180 which supports steering column 164.

Referring generally to FIGS. 2 and 3 and particularly to FIG. 1, first torque transmitting element 117 comprises a belt drive 138 transmitting torque from input shaft 116 to drive axle 132. Belt drive 138 includes an output shaft 144, a first sprocket 140 fixed to input shaft 116, and a second sprocket 142 fixed to output shaft 144. Torque transmitting element 117 in the example of FIGS. 1-3 is a belt spanning first and second sprockets 140, 142.

A third sprocket 146 is fixed to output shaft 118, a fourth sprocket 148 is fixed to drive axle 132, and second torque transmitting element 134 is a belt spanning third and fourth sprockets 146, 148. Sprockets 140, 142, 146, 148, may be varied in diameter to effect desired gearing ratios.

Arm 124 supporting pedal 122 may include a hub 188 which in turn may be integral with input shaft 116, or alternatively, may engage input shaft 116 for example by splines (not shown). Similarly, arm 130 terminates at a hub 188 engaging input shaft 116.

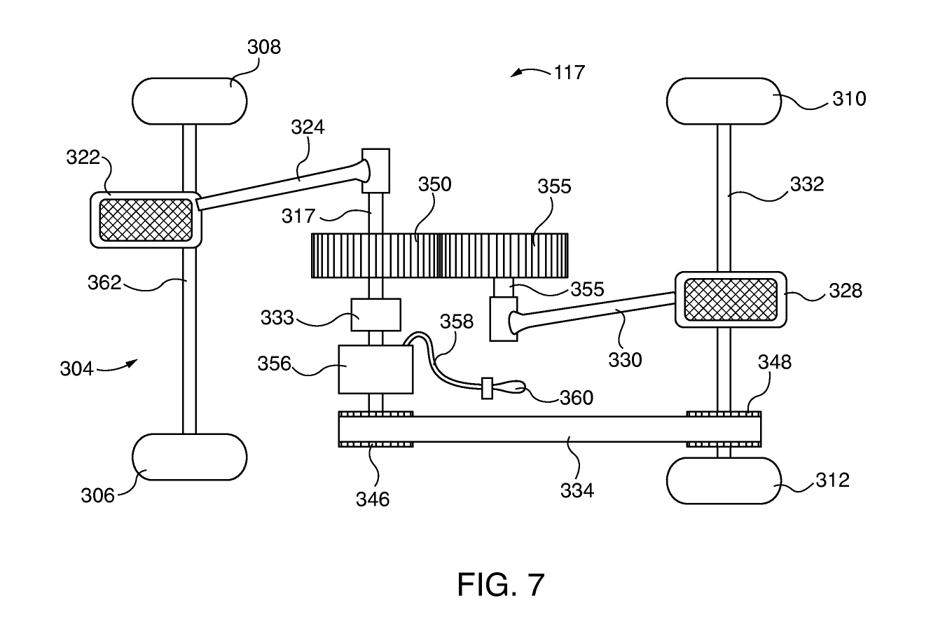

Turning now to FIG. 7, in an alternate embodiment, first torque transmitting element 117 of FIGS. 1 and 3 may comprise a series of mutually engaged gears such as gears 350 and 355. Gear 355 receives input from pedal 328 via arm 330, through a shaft 355. Unidirectional clutches, such as unidirectional clutches 133 and 333 may comprise ratchets assuring that gear 355 turns in the same direction as pedal 328 is depressed, while gear 350 turns in the opposite direction of gear 355 but is disengaged. Similarly, unidirectional clutches, such as unidirectional clutches 133 and 333 may comprise ratchets assuring that gear 350 turns in the same direction as pedal 322 is depressed while gear 355 turns in the opposite direction of gear 350 but is disengaged. Gears such as gears 350, 355 offer an alternative to belt 182. Also, vehicle 100 may comprise an enclosed gearset, such as enclosed gearset 356 of FIG. 7, for selectively varying ratios between input shaft rotational speeds and driven axle rotational speeds. Gearset 356 may be controlled using a flexible cable 358 having an operating lever 360 (mounted on chassis 102), in a manner similar to that of three-speed hubs of bicycles of past years (not shown). As noted above, unidirectional clutches, such as unidirectional clutches 133 and 333 may comprise ratchets, or alternatively, may include needle bearing clutches of conventional type.

In operation, a rider stands with one foot on pedal 122 and the other foot on pedal 128. The rider imposes his or her weight first on one pedal 122 or 128, and when the pedal 122 or 128 receiving the weight has moved fully to its lowermost position (i.e., at the bottom of arrows 123 and 125), the rider brings his or her weight to bear on the other pedal 128 or 122. That pedal 122 or 128 which had just been depressed rises to its highest postion, by a spring loaded return mechanism (not shown), and is prepared to once again receive weight and transfer force to input shaft 116. The user merely alternates imposing his or her body weight on first one pedal 122 or 128, then on the other pedal 128 or 122. Force is transmitted through pedal drive 114, ultimately rotating drive axle 132.

Vehicle 100 moves toward its forward end 104 responsive to force imposed from pedal drive 114. Unidirectional clutch 133 assures that inadvertent depression of pedal 122 or 128 will not cause vehicle 100 to lose momentum. Also, unidirectional clutch enables vehicle 100 to freewheel, or alternatively stated, to continue rolling due to inertia despite any absence of power inputs from pedal drive 114.

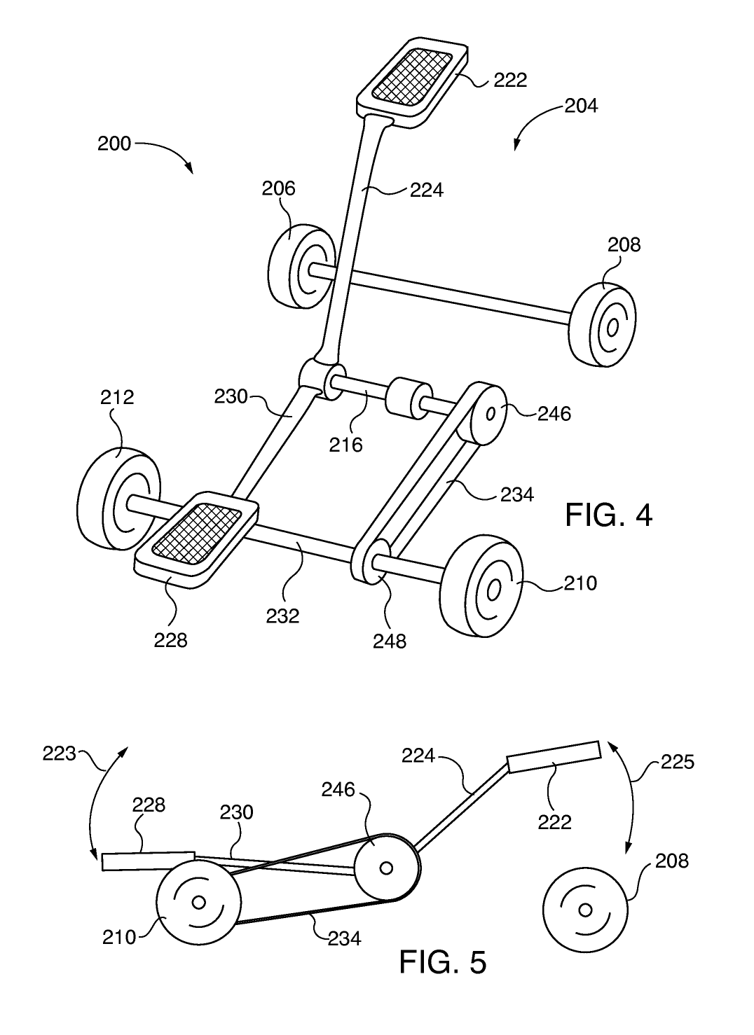

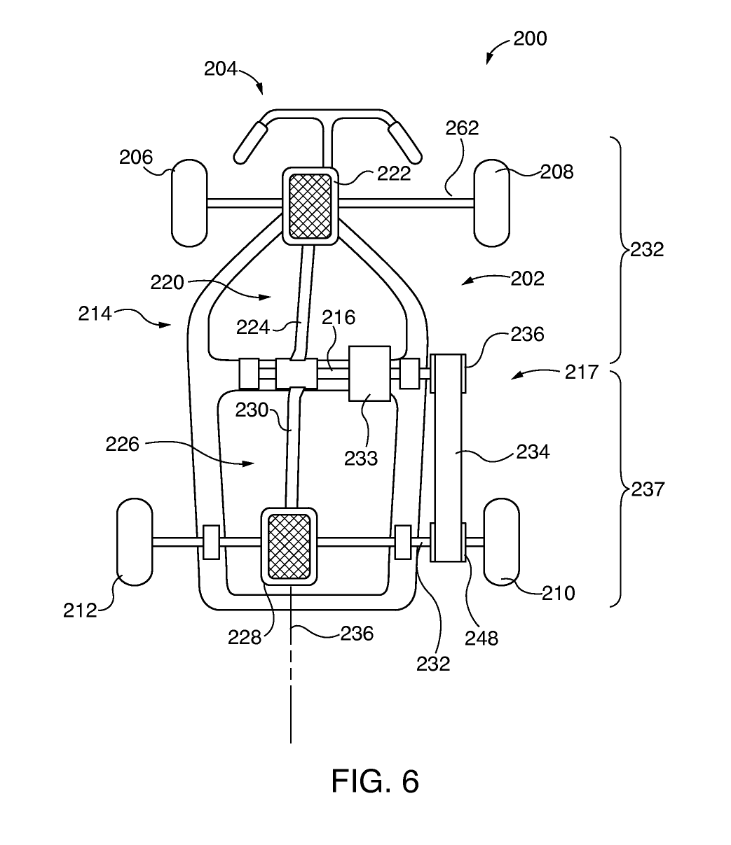

Turning now to FIGS. 4-6, a vehicle 200 according to at least one other aspect of the disclosure, which vehicle may be propelled by alternating depression of pedals, is shown. Vehicle 200 comprises a chassis 202 having a forward end 204, at least three wheels rotatably supported on the chassis 202, the at least three wheels including at least one unpowered wheel 206 or 208 and at least one driven wheel 210 or 212, and a pedal drive 214 for rotating the at least one driven wheel in a direction such that chassis 202 moves toward the forward end 204 when the at least one driven wheel is rotated by pedal drive 214. Pedal drive 214 includes an input shaft 216 rotatably supported by chassis 202, a torque transmitting element 217 arranged to transmit torque from input shaft 216 to a drive axle 332. A first pedal input assembly 220 is connected to input shaft 216, first pedal input assembly 220 comprising a first pedal 222 and a first arm 224 connecting first pedal 222 to input shaft 216. A second pedal input assembly 226 is connected to input shaft 216, second pedal input assembly 226 comprising a second pedal 228 and a second arm 230 connecting second pedal 228 to the input shaft 216. A drive axle 232 is fixed to the at least one driven wheel and rotatably connected to input shaft 216. A unidirectional clutch 233 is located between input shaft 216 and drive axle 232. Chassis 202 has a forward half and a rear half (these are not shown in FIGS. 4-6, but are similar to their similarly named counterparts in FIGS. 1-3). First pedal 222 is located over the forward half of chassis 202 and second pedal 228 is located over the rear half of chassis 202, just as with vehicle 100 of FIGS. 1-3.

Chassis 202 has a forward half 232 and a rear half 234. First pedal 222 is located over forward half 232 of chassis 202 and second pedal 228 is located over rear half 237 of chassis 202. Chassis 202 has a longitudinal center line 236. First pedal 222 is located on one side of longitudinal center line 236, and second pedal 228 is located on an opposed side of longitudinal center line 236.

The at least one driven wheel of vehicle 200 comprises two driven wheels 210, 212. The at least one unpowered wheel of vehicle 200 comprises two unpowered wheels 206, 208.

Pedal drive 214 includes an output shaft 218 rotatably supported by chassis 202. Output shaft 218 is parallel to input shaft 216. A second torque transmitting element 234 is arranged to transmit torque from output shaft 218 to drive axle 232.

First torque transmitting element 217 comprises belt drive 234 transmitting torque from input shaft 216 to drive axle 232. Belt drive 238 includes an output shaft 244, a first sprocket 240 fixed to input shaft 216, and a second sprocket 242 fixed to output shaft 244. In the example of FIGS. 4-6, torque transmitting element 217 is a belt spanning first and second sprockets 240, 242. First torque transmitting element 217 further comprises a third sprocket 246 fixed to output shaft 218, and a fourth sprocket 248 fixed to drive axle 232. Second torque transmitting element 234 is a belt spanning third and fourth sprockets 246, 248.

First torque transmitting element 217 comprises a series of mutually engaged gears 350, 355 (FIG. 7).

Vehicle 200 may further comprise an enclosed gearset 356 for selectively varying ratios between input shaft rotational speeds and driven axle rotational speeds.

Chassis 202 may have structural characteristics of chassis 102 of FIGS. 1-3, although specific details are not repeated for chassis 204. Similarly, rotatable components such as input shaft 216 and drive axle 232 are secured to chassis 202 by trunnion bearings, not specifically called out, but similar in nature to their corresponding counterparts in FIGS. 1-3. Front axle 262 is supported on chassis 202, and may be steered in the same way as with vehicle 100 of FIGS. 1-3.

Vehicle 200 is operated in a manner similar to that of vehicle 100. Pedals 222, 228 are alternately depressed and raised, as indicated by arrows 223 and 225, by having the rider teeter or shift body weight from one pedal 222 or 228 to the other pedal 228 or 222.

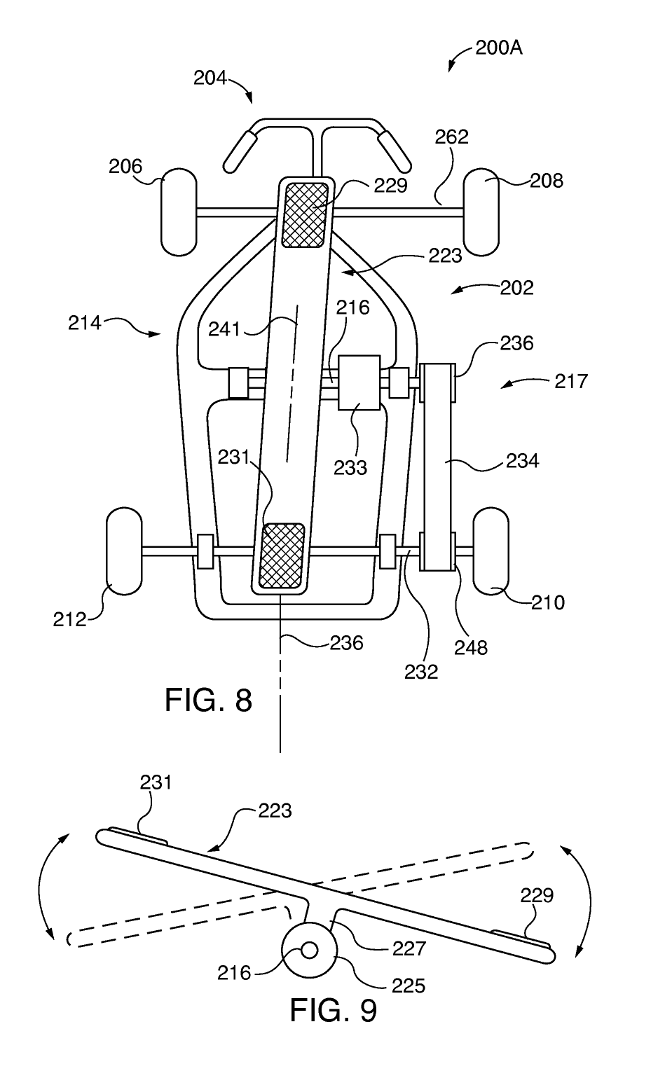

Referring to FIGS. 8 and 9, there is shown a variation of the vehicle 200, wherein a vehicle 200A has a chassis 204 similar to that of vehicle 200. The difference between vehicle 200 and vehicle 200A lies in configuration of pedals. Whereas vehicle 200 has two separate, discrete pedals 222, 228, by contrast, vehicle 200A has a single pedal 223 spanning the same foot positions provided by pedals 222 and 228. Pedal 223 provides the effect of a surfboard or skateboard (neither is shown), wherein one foot is placed towards the front of the surfboard or skateboard, and the other foot is placed towards the rear. Foot positions will be understood to correspond to pads 229, 231. Pads 229, 231, shown cross hatched, may comprise a friction surface such as treaded rubber, sandpaper, knurling, and others. Pads 229, 231 may be raised above the surrounding pedal 223, as shown in FIG. 8, may be flush with pedal 223, or may be recessed into pedal 223 (the latter options are not shown). Equivalent pads may be provided for pedals 122, 128, 222, 228 of vehicles 100 and 200, even though not explicitly shown and described.

Longitudinal orientation of pedal 223, represented in FIG. 8 as centerline 241, may be inclined relative to longitudinal center line 236 of chassis 202. Alternatively, longitudinal orientation of pedal 223 may be inclined relative to longitudinal center line 236, but with pad 229 to the left of longitudinal center line 236, or may be aligned parallel thereto (the latter two options are not shown).

Referring specifically to FIG. 9, pedal 223 may be secured to a hub 225 by an arm 227 spanning pedal 223 and hub 225. Hub 227 drivingly engages input shaft 216. Drive components of vehicle 200A, such as wheels 210 and 212, input shaft 216, drive axle 232, sprocket 248, and mounting of moving parts to chassis 202, may be similar to those of vehicle 200.

Unless otherwise indicated, the terms “first”, “second”, etc., are used herein merely as labels, and are not intended to impose ordinal, positional, or hierarchical requirements on the items to which these terms refer. Moreover, reference to, e.g., a “second” item does not either require or preclude the existence of, e.g., a “first” or lower-numbered item, and/or, e.g., a “third” or higher-numbered item.

Although the invention has been described in terms of the examples of FIGS. 1-7, other arrangements are possible. For example, pedals 122 and 128 or 222 and 228 may be arranged both one one side of the longitudinal centerline of their respective vehicles 100 or 200. The amount of offset from the centerline may be varied from the illustrated examples.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

It should be understood that the various examples of the apparatus(es) disclosed herein may include any of the components, features, and functionalities of any of the other examples of the apparatus(es) disclosed herein in any feasible combination, and all of such possibilities are intended to be within the spirit and scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples presented and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims.

I claim:

1. A vehicle which may be propelled by alternating depression of pedals, comprising:
a chassis having a forward end;
at least three wheels rotatably supported on the chassis, the at least three wheels including at least one unpowered wheel and at least one driven wheel; and
a pedal drive for rotating the at least one driven wheel in a direction such that the chassis moves toward the forward end when the at least one driven wheel is rotated by the pedal drive, the pedal drive including:
an input shaft rotatably supported by the chassis,
a first torque transmitting element arranged to transmit torque from the input shaft to the output shaft,
a first pedal input assembly connected to the input shaft, the first pedal input assembly comprising a first pedal and a first arm connecting the first pedal to the input shaft,
a second pedal input assembly connected to the input shaft, the second pedal input assembly comprising a second pedal and a second arm connecting the second pedal to the input shaft,
a drive axle fixed to the at least one driven wheel and rotatably connected to the input shaft, and
a unidirectional clutch located between the input shaft and the drive axle, wherein
the first pedal input assembly and the second pedal input assembly are connected to the input shaft such that when the first pedal is being depressed, the second pedal is rising, and
the chassis has a forward half and a rear half, the first pedal is located over the forward half of the chassis. and the second pedal is located over the rear half of the chassis.

2. The vehicle of claim 1, wherein the at least one driven wheel comprises two driven wheels.

3. The vehicle of claim 1, wherein the at least one unpowered wheel comprises two unpowered wheels.

4. The vehicle of claim 1, wherein the chassis has a longitudinal center line, the first pedal is located on one side of the longitudinal center line, and the second pedal is located on an opposed side of the longitudinal center line.

5. The vehicle of claim 1, wherein the pedal drive includes an output shaft rotatably supported by the chassis, the output shaft parallel to the input shaft, and a second torque transmitting element arranged to transmit torque from the output shaft to the drive axle.

6. The vehicle of claim 5, wherein the first torque transmitting element comprises a belt drive transmitting torque from the input shaft to the driven axle, the belt drive including:
an output shaft, a first sprocket fixed to the input shaft, a second sprocket fixed to the output shaft, wherein the torque transmitting element is a belt spanning the first and second sprockets; and
a third sprocket fixed to the output shaft, a fourth sprocket fixed to the driven axle, and the second torque transmitting element is a belt spanning the third and fourth sprockets.

7. The vehicle of claim 1, wherein the first torque transmitting element comprises a series of mutually engaged gears.

8. The vehicle of claim 1, further comprising an enclosed gearset for selectively varying ratios between input shaft rotational speeds and driven axle rotational speeds.

9. A vehicle which may be propelled by alternating depression of pedals, comprising:
a chassis having a forward end;
at least three wheels rotatably supported on the chassis, the at least three wheels including at least one unpowered wheel and at least one driven wheel; and
a pedal drive for rotating the at least one driven wheel in a direction such that the chassis moves toward the forward end when the at least one driven wheel is rotated by the pedal drive, the pedal drive including:
an input shaft rotatably supported by the chassis,
a first torque transmitting element arranged to transmit torque from the input shaft to the output shaft,
a first pedal input assembly connected to the input shaft, the first pedal input assembly comprising a first pedal and a first arm connecting the first pedal to the input shaft,
a second pedal input assembly connected to the input shaft, the second pedal input assembly comprising a second pedal and a second arm connecting the second pedal to the input shaft,
a drive axle fixed to the at least one driven wheel and rotatably connected to the input shaft, and
a unidirectional clutch located between the input shaft and the drive axle, wherein
the chassis has a forward half and a rear half, the first pedal is located over the forward half of the chassis. and the second pedal is located over the rear half of the chassis.

10. The vehicle of claim 9, wherein the at least one driven wheel comprises two driven wheels.

11. The vehicle of claim 9, wherein the at least one unpowered wheel comprises two unpowered wheels.

12. The vehicle of claim 9, wherein the chassis has a longitudinal center line, the first pedal is located on one side of the longitudinal center line, and the second pedal is located on an opposed side of the longitudinal center line.

13. The vehicle of claim 9, wherein the pedal drive includes an output shaft rotatably supported by the chassis, the output shaft parallel to the input shaft, and a second torque transmitting element arranged to transmit torque from the output shaft to the drive axle.

14. The vehicle of claim 13, wherein the first torque transmitting element comprises a belt drive transmitting torque from the input shaft to the driven axle, the belt drive including:
an output shaft, a first sprocket fixed to the input shaft, a second sprocket fixed to the output shaft, wherein the torque transmitting element is a belt spanning the first and second sprockets; and
a third sprocket fixed to the output shaft, a fourth sprocket fixed to the driven axle, and the second torque transmitting element is a belt spanning the third and fourth sprockets.

15. The vehicle of claim 9, wherein the first torque transmitting element comprises a series of mutually engaged gears.

16. The vehicle of claim 9, further comprising an enclosed gearset for selectively varying ratios between input shaft rotational speeds and driven axle rotational speeds.
